(19) United States
(12) Patent Application Publication
(10) Pub. No.: US 2026/0145749 A1
(43) Pub. Date: May 28, 2026

(54) FLEXIBLE VANE FOR VISIBLE ACTIVE AERODYNAMIC GRILL SHUTTER ASSEMBLY

(71) Applicant: Magna Exteriors Inc., Aurora (CA)

(72) Inventor: Jeffrey B. Manhire, Rochester, MI (US)

(21) Appl. No.: 19/454,907

(22) Filed: Jan. 21, 2026

Related U.S. Application Data
(63) Continuation of application No. PCT/US2024/039004, filed on Jul. 22, 2024.
(60) Provisional application No. 63/514,879, filed on Jul. 21, 2023.

(51) Int. Cl. B62D 35/00

(52) U.S. Cl. CPC B62D 35/005

(57) ABSTRACT

A contour morphing active grill structure for a vehicle has at least one vane which is actuatable between a closed and an open position. The vane is pivoted along a first axis and a portion of the vane includes a pivot that defines a second axis that is not co-axial with the first axis so that the vane flexes into a predetermined contoured surface when said vane is closed thereby matching a contoured surface of the vehicle.

### CROSS REFERENCE TO RELATED APPLICATIONS

This application is a continuation Application of PCT International Application No. PCT/US2024/039004 filed on Jul. 22, 2024 which claims priority to U.S. Provisional Ser. No. 63/514,879 filed on Jul. 21, 2023, the entire contents of which are incorporated herein by reference.

### TECHNICAL FIELD

The present disclosure relates to a flexible vane for visible active aerodynamic grill shutter assembly.

### BACKGROUND

Current visible active grille shutter (AGS) assemblies show appearance concerns with the vanes in the open position due to the plan view sweep across the front of the vehicle, as this curvature is shown as bent-looking vanes when they are open. This design concept will allow the vanes to follow the curvature of the vehicle but appear flat when open.

It is therefore an object of the present invention to design an improved visible active grill shutter design, which, in at least some implementations, will match the styling at the front of the vehicle while in the closed position and appear flat while open.

### SUMMARY

The disclosure relates generally to a contour morphing active grill structure for a vehicle. The grill structure includes at least one vane which is actuatable between a closed and an open position. The vane is pivoted along an axis by opposed pivot points. A third pivot portion of the vane is not coaxially with the opposed pivot points and may include an off-center pivot axis such that when the vane is opened or moved from a first position the off-center pivot axis flexes the vane into a predetermined contoured surface than when the vane is in the first position thereby matching a contoured surface of the vehicle.

Generally, vanes are designed to be as stiff as possible to minimize deflection while in use. This design concept makes the vanes somewhat flexible, to allow them to bend by means of an offset pivot at the center of the vanes, to improve their appearance while open.

Typical AGS vanes are connected to their support frame by a pivot at each end; very long vanes may have a middle support, to limit deflection—all pivots are in line with each other, to allow the vane to rotate without binding. This disclosure relates to a somewhat flexible vane with a middle support to provide a location for a third pivot which is offset from the outer and inner pivots, to provide a means of bending the vane so it appears flat while in the open position.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present disclosure will become more fully understood from the detailed description and the accompanying drawings, wherein:

FIG. 1 is a view of a prior art type fixed vane arrangement;

FIG. 2 is a front perspective view of the flexible vane assembly;

FIG. 3 is a perspective view of a vane of the vane assembly when in the closed position;

FIG. 4 is a perspective view of a vane of the vane assembly showing the vane of FIG. 3 in the contoured or morphed position;

FIG. 5 is a sectional view of the vane of FIGS. 3 and 4 illustrating the weakened cross-section of the vane which allows the vane to be contoured and morphed in the closed position;

FIG. 6 is a rear perspective view showing the pivot in the open position which matches the end pivots for creating the flat configuration of the vane;

FIG. 7 is a side view of a vane; and

FIG. 8 is a rear perspective view showing detail of the pivot actuation of a vane.

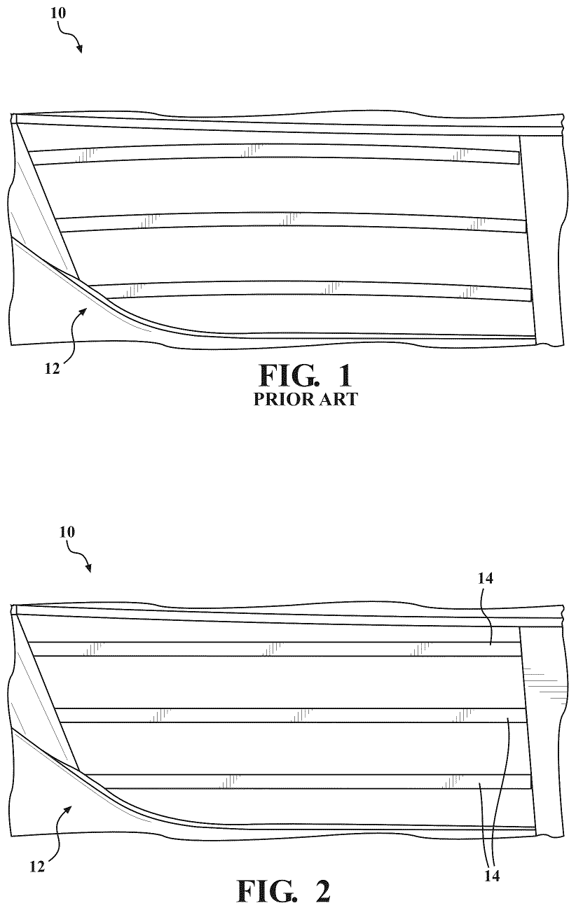

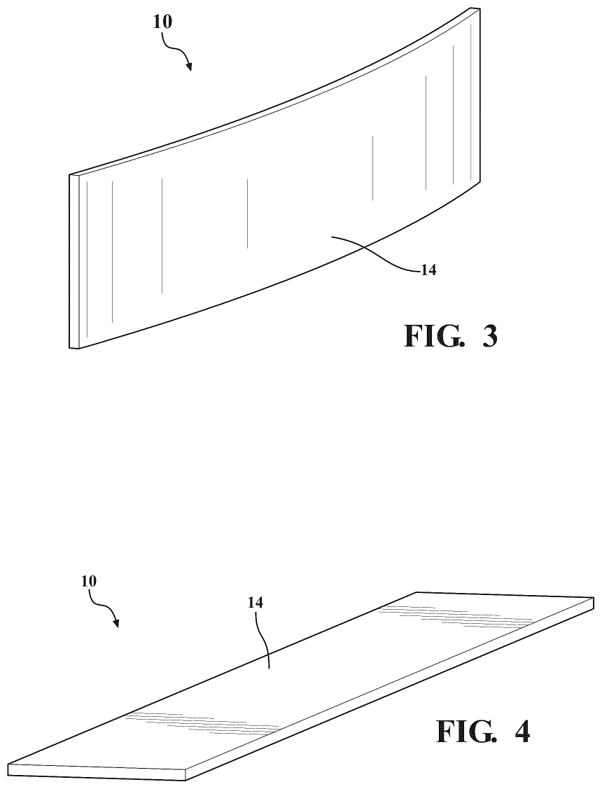

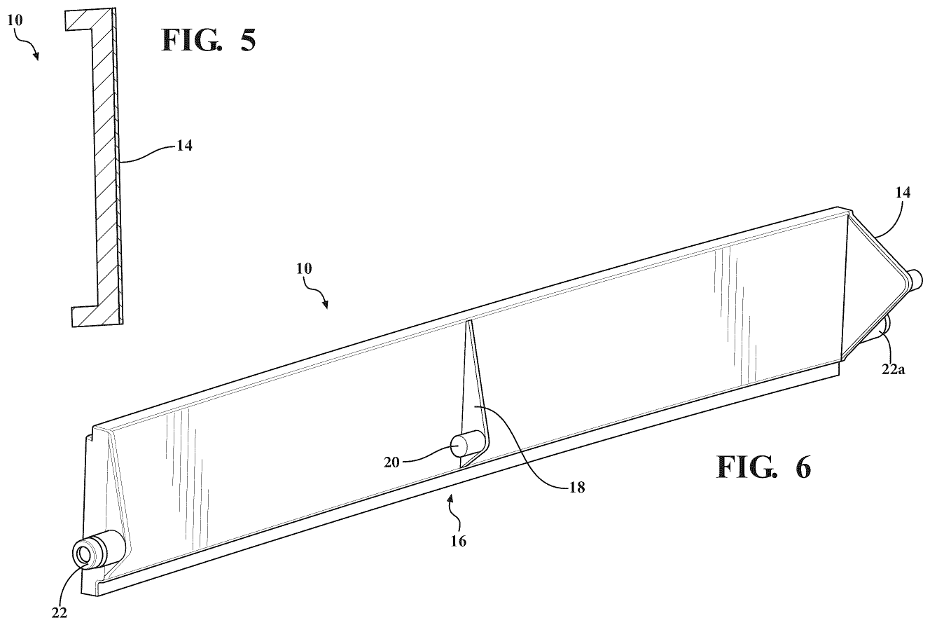

### DETAILED DESCRIPTION

The following description of the preferred embodiment(s) is merely exemplary in nature and is in no way intended to limit the invention, its application, or uses.

Referring now to the drawings, there is provided a contour morphing active grill structure generally shown at 10 for a vehicle 12.

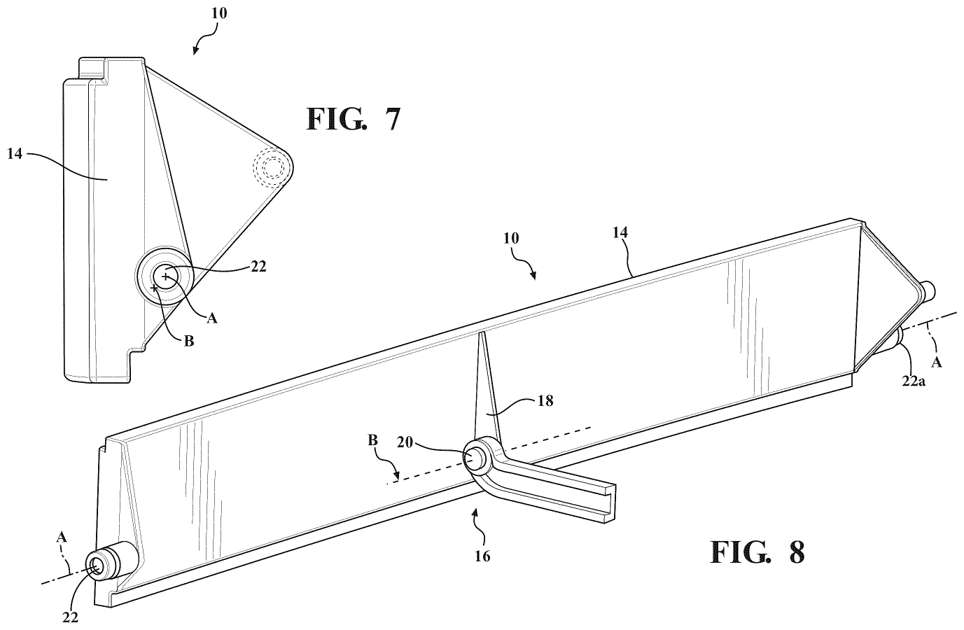

The contour morphing active grill structure 10 includes at least one vane 14 which is actuatable between a closed and an open position. The vane 14 is being pivoted along a first axis A-A and a portion of the vane 14 includes an off-center pivot axis B-B (FIG. 7) which is located in this embodiment at the center 16 of the vane 14. The off-center pivot along axis B-B flexes the vane 14 as shown in FIG. 4 into a predetermined contoured surface when said vane is closed thereby matching a contoured surface of the vehicle 12. As shown in FIGS. 6 and 8, the pivot includes a base member 18 attached to the vane 14 for reinforcing the off-center pivot axis B-B.

As will be readily appreciated, the vane 14 is made from a flexible material which will allow it to morph into the predetermined shaped contour. As shown in FIG. 2 a plurality of flexible vanes 14 is used to provide a front active grill structure in the vehicle. The shape, number and location of the off-center axis B-B may be varied depending on the desired shape of the contoured surface when the vane is closed.

Preferably, a pair of co-axial pivots 22 and 22a are provided adjacent outer peripheral ends and an off-center pivot 20 along axis B-B is provided at the middle area 16 of the vane. In this context, “off-center” means that the pivot 20 is not coaxial with the pivots 22 and 22a, and the second axis B-B is offset from and not coaxial with the first axis A-A, as shown in FIG. 7. In the example shown in FIG. 7, the axis B-B is offset toward a front or outer face of the vane compared to the axis A-A, and may be lower or closer to a lower side of the vane compared to the axis A-A.

An actuator and linkage (not shown) pivots the vanes adjacent to an end portion of the vane and the center pivot moves as the vanes are pivoted. Because of the preconfigured off set of the center pivot axis B-B the vane morphs from a flat open position where the blades are substantially linear to a contoured vehicle contour position where the vane is in a second three dimensionally pre-defined contour.

As shown above, the blade is designed to be at least one blade but preferably is a series of such blades which form an active grill of a vehicle. The blades are designed to morph when pivoting from a first position to a second position. Typically, the blades are designed to be contoured to a vehicle surface when in the closed position but to then have a flatter profile in the open position. However, if desired the vanes are arranged for being contoured when in the open position and flat when in the closed position.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A contour morphing active grill structure for a vehicle, comprising:
at least one vane which is actuatable between a first position and a second position;
said vane being pivoted along a first pivot axis and a portion of the vane including a second pivot axis that is not coaxial with the first pivot axis wherein the second pivot axis flexes the vane into a predetermined contoured surface when said vane is moved from one of said first position or second position to the other of said first position or second position thereby matching a contoured surface of the vehicle in one of said first position or said second position.

2. The contour morphing active grill structure of claim 1 wherein the first position is a closed position and the second position is an open position.

3. The contour morphing active grill structure of claim 1 wherein said vane appears flat when in the open position and is contoured to match a vehicle surface in a closed position.

4. The contour morphing active grill structure for a vehicle of claim 1 wherein the vane is made from a flexible material.

5. The contour morphing active grill structure for a vehicle of claim 1 wherein a pair of co-axial pivots define the first pivot axis and are provided adjacent outer peripheral ends and a third pivot is provided at the middle area of the vane and the third pivot defines the second pivot axis.

6. The contour morphing active grill structure for a vehicle of claim 5 wherein an actuator pivots the vane adjacent to an end portion of the vane and the third pivot moves as the vane is pivoted.

7. A contour morphing active grill structure for a vehicle, comprising:
at least one vane which is actuatable between a closed and an open position;
said vane being pivoted along a first axis and a portion of the vane including a pivot that defines a second pivot axis wherein by the second pivot axis flexes the vane into a predetermined contoured surface when said vane is closed thereby matching a contoured surface of the vehicle.

8. The contour morphing active grill structure for a vehicle of claim 7 wherein the vane is made from a flexible material.

9. The contour morphing active grill structure for a vehicle of claim 7 wherein a pair of co-axial pivots define the first axis and are provided adjacent outer peripheral ends and the pivot that defines the second pivot axis is provided at the middle area of the vane.

10. The contour morphing active grill structure for a vehicle of claim 9 wherein an actuator pivots the vane adjacent to an end portion of the vane and the pivot that defines the second pivot axis moves as the vane is pivoted.

11. A contour morphing active grill structure for a vehicle, comprising:
at least one vane which is actuatable between a first position and a second position;
said vane being pivoted along a first axis by a first set of coaxial pivots and a portion of the vane including another pivot attached to the vane and operable to pivot on a second axis that is different than said first axis wherein said another pivot causes the vane to flex into a predetermined contoured surface when said vane is moved from one of said first position or second position to the other of said first position or second position thereby matching a contoured surface of the vehicle in one of said first position or said second position.

12. The contour morphing active grill structure of claim 11 wherein the first position is a closed position and the second position is an open position.

13. The contour morphing active grill structure of claim 11 wherein said vane appears flat when in the open position and is contoured to match a vehicle surface in a closed position.

14. The contour morphing active grill structure for a vehicle of claim 12 wherein the vane is made from a flexible material.

15. The contour morphing active grill structure for a vehicle of claim 11 wherein the vane is made from a flexible material.

16. The contour morphing active grill structure for a vehicle of claim 11 wherein the first set includes a pair of co-axial pivots that are provided adjacent outer peripheral ends of the vane, and a said another pivot is provided at the middle area of the vane.

17. The contour morphing active grill structure for a vehicle of claim 16 wherein an actuator pivots the vane adjacent to an end portion of the vane and the center pivot moves as the vane is pivoted.
